(19) United States
(12) Patent Application Publication
(10) Pub. No.: US 2011/0147647 A1
(43) Pub. Date: Jun. 23, 2011

(54) CARBON-CONTAINING MATRIX WITH ADDITIVE THAT IS NOT A METAL

(75) Inventors: Zvi Yaniv, Austin, TX (US); Nan Jiang, Austin, TX (US); James Novak, Austin, TX (US)

(73) Assignee: Applied Nanotech, Inc., Austin, TX (US)

(21) Appl. No.: 12/793,656

(22) Filed: Jun. 3, 2010

Related U.S. Application Data
(60) Provisional application No. 61/184,549, filed on Jun. 5, 2009.

(51) Int. Cl. C09K 5/00

(52) U.S. Cl. 252/75; 252/71; 252/74

(57) ABSTRACT

An article of manufacture comprises a carbon-containing matrix. The carbon-containing matrix may comprise at least one type of carbon material selected from the group comprising graphite crystalline carbon materials, carbon powder, carbon fibers, artificial graphite powder, or combinations thereof. In addition, the carbon-containing matrix comprises a plurality of pores. The article of manufacture also comprises an additive that is not a metal pressure disposed within at least a portion of the plurality of pores.

### PRIORITY CLAIM AND CROSS-REFERENCE TO RELATED APPLICATION

This application claims the benefit under 35 U.S.C. §119(e)(1) of U.S. Provisional Application No. 61/184,549, filed Jun. 5, 2009, which is hereby incorporated by reference.

### BACKGROUND

This application is directed to filling pores of a carbon-containing matrix with an additive that is not a metal to enhance physical properties and thermal properties of the resulting carbon additive composite.

### SUMMARY

The instant composition of matter comprises a carbon-containing matrix. The carbon-containing matrix may contain at least one type of carbon material, such as graphite crystalline carbon materials, carbon powder, and artificial graphite powder, carbon fibers, or combinations thereof. The carbon-containing matrix may be formed as a block, a cloth, a sheet, or a plate. The carbon-containing matrix may also be amorphous. In addition, the carbon-containing matrix has a plurality of pores. The composition of matter also has an additive that is not a metal pressure disposed within at least a portion of the plurality of pores. The additive may include materials, such as polyurethanes, epoxies, nylons, Si, SiC, C, and combinations thereof. Further, the additive that is not a metal disposed within the pores of the carbon-containing matrix improves the flexibility and strength of the carbon additive composite. For example, the composition of matter may have a bending strength in the range of 3.5 MPa to 10.0 MPa.

The additive may be disposed in the pores of the carbon-containing matrix via a chemical reaction. For example, one or more pre-cursors may be disposed within the pores that react with the carbon of the carbon-containing matrix to form the additive that is not a metal. Pressure and/or heat may be applied to initiate one or more reactions that dispose the additive within the pores of the carbon-containing matrix based on the one or more pre-cursors.

In some instances, the one or more pre-cursors are not metals. Additionally, the pre-cursors may be polymeric, such as silicones, polyurethanes, epoxies, nylons, or mixtures thereof. The pre-cursor may also be SiH₄ gas. When the pre-cursor is an Si-containing material, the additive disposed within the pores of the carbon-containing matrix may include SiC. The SiC disposed within the pores of the carbon-containing matrix may improve the strength, flexibility, and thermal conductivity of the carbon additive composite. The pre-cursor(s) may also include thermal conductivity additives to increase the thermal conductivity of the additive that is not a metal, such as carbon nano-tubes, particulate graphite, graphene sheets, C₆₀ (Buckminster Fullerene), and combinations thereof. In some cases, the pre-cursor(s) may include metallic thermal conductivity additives, such as nano-particulate metal, carbon-metal composite dust, or combinations thereof.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and elements.

FIGS. 1A and 1B show a Scanning Electron Microscope (SEM) image of higher quality acicular coke and lower quality coke.

FIG. 2 illustrates SEM images of coarse graphite particle structures and fine graphite particle structures.

FIG. 3 is a flow diagram showing a method for making an exemplary carbon-containing matrix.

FIG. 4 shows Transmission Electron Microscope (TEM) images of a carbon-containing matrix.

FIGS. 5A and 5B show additional TEM images of the nanographitic plates of the carbon-containing matrix.

FIGS. 6A and 6B show TEM diffraction patterns and images of the carbon-containing matrix.

FIG. 7 shows a flow diagram of a method of disposing an additive that is not a metal within pores of a carbon-containing matrix.

FIGS. 8A-8C show microscopy photographs of a carbon-containing matrix before and after disposing silicone grease within pores of the carbon-containing matrix.

FIGS. 9A and 9B illustrate heat transfer devices that may utilize a carbon additive composite.

FIG. 10 shows applications of a polymer including thermal conductivity additives.

FIG. 11 illustrates heat transfer through a polymer including thermal conductivity additives.

### DETAILED DESCRIPTION

Thermal conductivity may be based upon three major contributions; electron, phonon and magnetic. The total thermal conductivity (equation 1) can be written as a sum of each contributing term:

kₜₒₜₐₗ=k_{electronic}+kₚₕₒₙₒₙ+k_{magnetic} Eq. 1

The first contribution, k_{electronic}, is due to electron-electron interactions between materials. Energy transfer via electron-electron interactions is a direct effect of shared electrons within a crystal structure. The second term, kₚₕₒₙₒₙ, is related to phonon coupling. A phonon is a lattice vibration within a crystal structure. These lattice vibrations can propagate through a material to transfer thermal energy. Highly ordered materials with regular, crystalline lattice structures transfer energy more efficiently than regio-regular or non-crystalline materials. The third contribution to thermal conductivity, k_{magnetic}, relies on magnetic interactions. Increased energy transfer via magnetic interactions may be due to aligned electron spin and the resulting coupling between the spins.

Thermal characteristics of composites, such as composites of a material A and a material B, may be affected by the quality and the nature of the interfaces between the grains of material A and the grains of material B. In particular, the quality of the interfaces that form the composite may be affected by: the quality of phonon coupling and phonon propagation between the grains of materials A and materials B; the creation of compounds of AₓB_{y} that change the nature of the interface and change the expected value of the thermal impedance at the interface; and the adhesion strength at the interfaces of grains of A and B, where the adhesion strength may affect not only the thermal properties but also the final mechanical strength of the composite.

Thermal management materials may be used to dissipate heat from heat producing devices. In particular, some devices may not function properly or may be destroyed when exposed to certain amounts of heat. Thus, thermal management materials may be used as heat sinks and heat spreaders for devices, such as computer chips, light emitting diode (LED) packaging, solar cell boards, high-load capacitors, and high-load semiconductors.

Some thermal management materials having a high thermal conductivity are formed from a carbon-containing matrix that has a high degree of crystalline order. The carbon-containing matrix may be produced by compressing carbonaceous materials under high pressure and high temperature. The carbon-containing matrix may be rigid and porous having a high surface area. The pore size of the carbon-containing matrix may range from millimeters to nanometers. In addition to having a high thermal conductivity, the carbon-containing matrix may also be electrically conductive.

In some cases, the pores of the carbon-containing matrix may be filled by injecting molten metal, such as Al, Mg, Cu, and Ni, into the pores at high pressure. The resulting carbon-metal composite is rigid. In addition, the metal injected into the pores may not have good wettability with the carbon of the carbon-containing matrix. Thus, the interface between the carbon-containing matrix and the metal may have a number of fracture planes producing a carbon-metal composite that is brittle. Consequently, the utility of the carbon-metal composites is limited in applications that require a flexible thermal management material that can conform to non-regular and non-planar surfaces. Additionally, the carbon-metal composite is limited in applications that expose the thermal management material to vibrations that may crack the carbon-metal composite.

The instant carbon additive composite includes a porous carbon-containing matrix with an additive that is not a metal disposed within at least a portion of the pores. The instant carbon additive composite has improved physical properties and increased flexibility based on the nature of the additive disposed within the pores of the carbon-containing matrix. For example, some additives may increase the bending strength more than others. In addition, the additive disposed within the pores of the carbon-containing matrix may improve the thermal properties of the carbon additive composite. The instant carbon additive composite may also be electrically conductive to provide some protection from electrostatic discharge and also provide grounding of radio frequency (RF) noise.

A chemical reaction may be initiated between a pre-cursor disposed within the pores of the carbon-containing matrix and carbon of the carbon-containing matrix. In some cases, the chemical reaction may start by increasing pressure and/or temperature of the carbon-containing matrix and the pre-cursor. In particular, a high pressure impregnating reaction (HPIR) process may be used to dispose an additive that is not a metal within the pores of the carbon-containing matrix. The temperature of the HPIR process is lower than the temperatures utilized to inject metals into the pores of the carbon-containing matrix. Accordingly, the cost of filling the pores of the carbon-containing matrix is reduced.

Additionally, low melting point pre-cursors may be utilized to produce a desired additive that is not a metal having increased affinity to the carbon-containing matrix, resulting in increased thermal conductivity due to increased phonon coupling and propagation at the additive/carbon interface. Further, the pores of the carbon-containing matrix may be filled with high melting point additives that are not metals formed from the chemical reaction of low-melting point pre-cursors. Thus, energy is conserved and costs reduced by disposing the additive in the pores of the carbon-containing matrix via a chemical reaction, which is different than filling the pores of the carbon-containing matrix with the additive in liquid form because the reaction can take place at temperatures lower than the melting point of the additive.

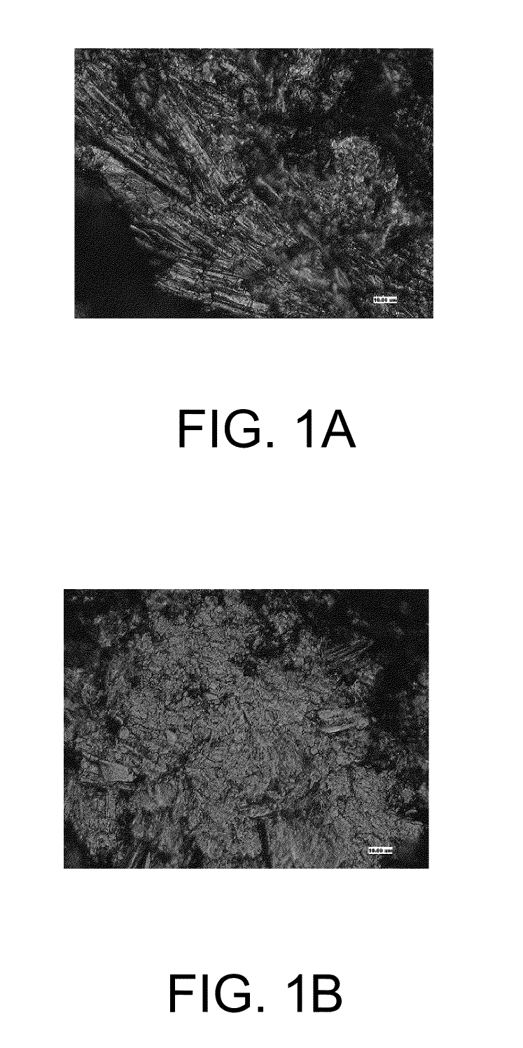

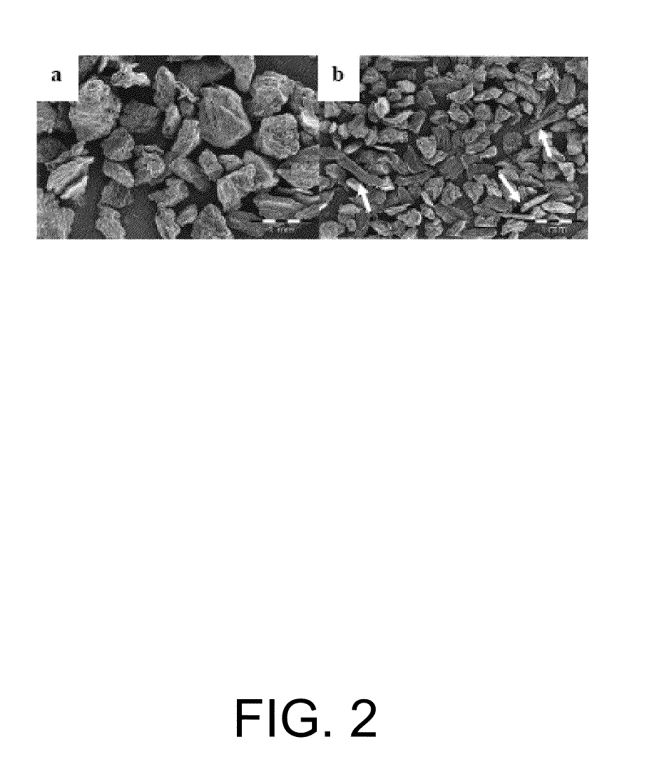

The graphitic carbon of the carbon-containing matrix may be based upon industrial coke products. This carbon residue can be derived from natural sources or from refining processes, such as in the coal and petroleum industries. In some exemplary embodiments, higher quality acicular coke derived from petroleum products may be utilized to form the carbon-containing matrix. FIG. 1A shows a Scanning Electron Microscope (SEM) image of higher quality acicular coke compared to lower quality coke shown in FIG. 1B. Pitch/tar may also be added to the acicular coke to function primarily as a binder and is turned to graphitic carbon during heating at a temperature of 2600° C. or higher, typically in the range of 3200° C. to 3600° C. The raw graphite material may include coarse and fine graphite particles with an average size in the range of 0.2 mm to 2 mm. In some cases, about 10% of the particles exhibit ellipse-like shape. FIG. 2 illustrates SEM images of coarse particle structures in the picture labeled “a” and fine particle structures in the picture labeled “b” with ellipse-like particles indicated by arrows.

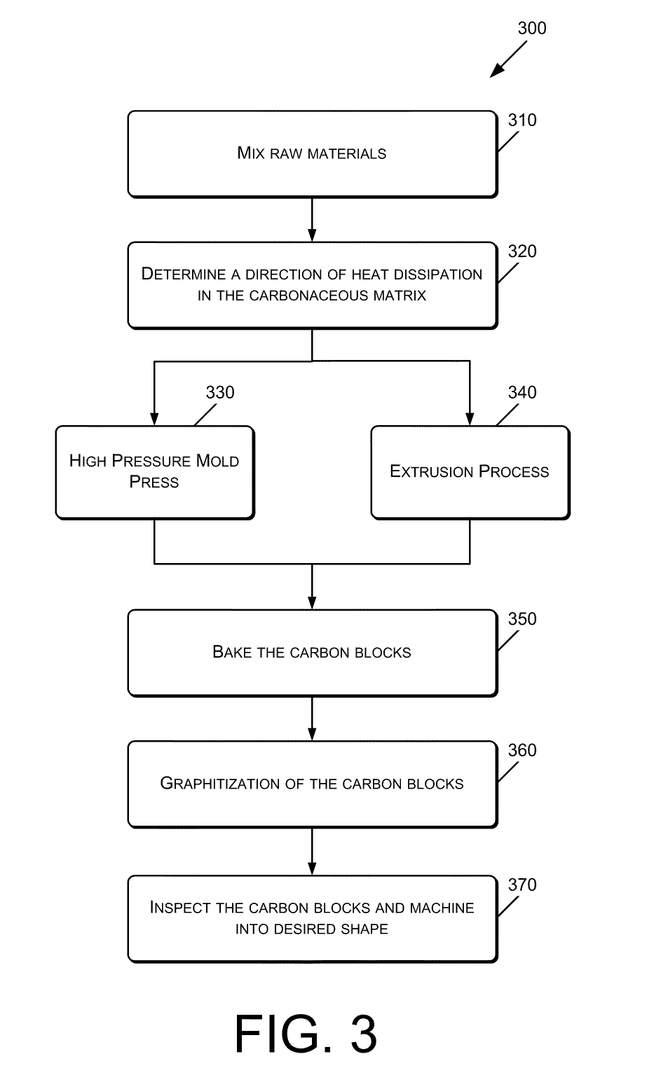

FIG. 3 is a flow diagram showing a method 300 for making a carbon-containing matrix. At 310, the raw materials are mixed together. During the mixing process, three raw materials may be used—petroleum cork, needle cork, tar (liquid), or a combination thereof. The needle cork may be used to control the shape of the carbon-containing matrix and lower the resistivity of the final carbon-containing matrix. The liquid tar may also used to control the shape of the carbon block and fill in pores of the carbon-containing matrix. The petroleum cork and the needle cork are crushed and mixed at a ratio of about 10:1, although different ratios may be used. The mixture is then subjected to a calcining process at about 500° C. or higher to evaporate impurities, such as sulfur. The liquid tar is then dosed into the mixture. Needle cork and tar may also be used to make the carbon-containing matrix without the petroleum cork because the needle cork has a higher carbon content, lower sulfur content, lower thermal expansion coefficient, higher thermal conductivity, and is easier to form than the petroleum cork.

At 320, the method 300 includes determining a direction of heat dissipation in the carbon-containing matrix. For example, a carbon-containing matrix may dissipate heat faster in the Z-direction when the carbon-containing matrix is manufactured utilizing an extrusion process. In another example, a carbon-containing matrix may dissipate heat faster in the XY direction when the carbon-containing matrix is manufactured utilizing a high pressure mold press. When heat dissipation along the XY direction is specified, then the method 300 moves to 330 where the carbon-containing matrix is formed by placing the raw materials in a high pressure mold press at a pressure higher than 50 MPa. Otherwise, when heat dissipation along the Z direction is specified, then the method 300 moves to 340.

At 340, the raw materials mixture of petroleum cork, needle cork, and/or tar is fed into an extruding process to form carbon blocks based on the shape and size of a mold utilized to make the carbon-containing matrix. In an illustrative embodiment, a carbon mold may be cylindrical with a diameter of about 700 mm and a length of about 2700 mm having a weight of at least about 1 ton. However, the dimensions of the mold can be changed based on the capabilities of the processing facility. The extruding process may be performed at a temperature range of 500° C. to 800° C. The force utilized to press the mixture into a column shape is about 3500 tons applied for about 30 minutes. In some instances, the extruded carbon blocks may be processed using a high pressure mold press. The carbon blocks are then transferred to a cooling water bath to cool down in order to prevent cracking.

At 350, the blocks are baked. The baking process can carbonize the tar at high temperature and eliminate volatile components. In some scenarios, the carbon blocks are transported from the cooling bath to an oven and heated at a temperature of about 1600° C. The carbon blocks may be baked for a duration in the range of 2 to 3 days. After the baking process, the surface of the carbon blocks may become rougher and porous. In addition, the diameter of the carbon block may decrease by about 10 mm.

At 360, graphitization takes place by heating the carbon block at a temperature in a range of 3200° C. to 3600° C. In some embodiments, graphitization will start at about 2600° C. with higher quality graphite forming at about 3200° C. In particular, at about 3000° C., stacking of graphitic plates of the carbon block may become parallel and turbostatic disorder decreases or is eliminated. In some cases, the carbon block may be heated to a lower temperature to produce crystallized graphite if the heating occurs at higher pressures. The carbon blocks may be heated for about 2-3 days. During the heating process, sulfur and volatile components of the carbon block may be reduced or completely eliminated.

At 370, the carbon blocks are inspected and machined into a desired shape. For example, electrical properties of the carbon blocks may be tested and mechanical cracking or visually identifiable defects are checked prior to the next stages of production. After testing, the carbon-containing matrix may then be machined to specific shapes according to the use of the carbon blocks.

The carbon-containing matrix may include various forms of carbon and trace amounts of other materials. For example, the carbon-containing matrix may include graphite crystalline carbon materials, carbon powder, artificial graphite powder, carbon fibers, or combinations thereof. The carbon-containing matrix block may have a density in a range of 1.6 g/cm³ to 1.9 g/cm³. In addition, the resistivity of the carbon block may be in a range between 4 μΩm to 10 μΩm. In some instances, the resistivity of the carbon-containing matrix is about 5 μΩm. A lower resistivity of the carbon block may indicate better alignment of the graphitic sheets of the carbon-containing matrix, which may also provide a higher thermal conductivity.

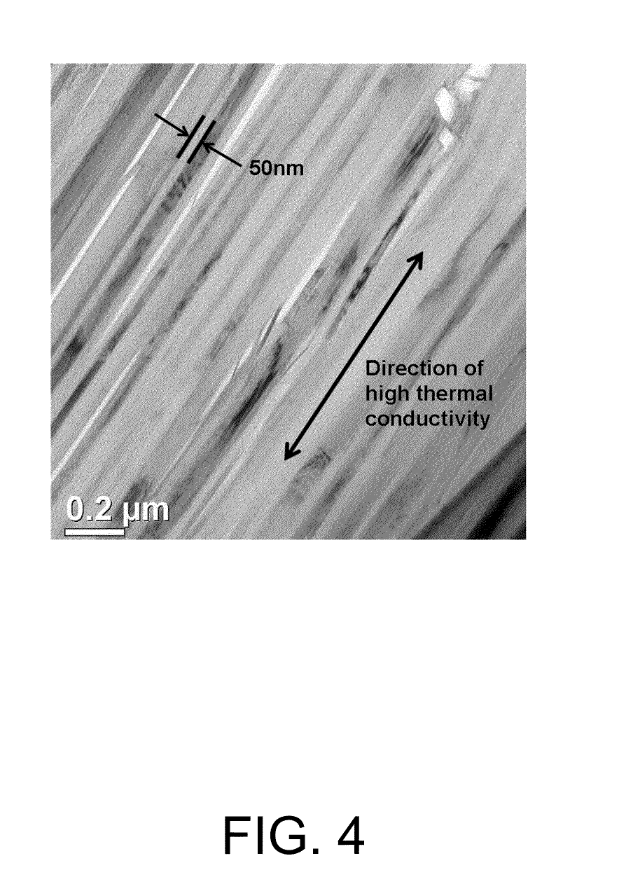

FIG. 4 shows Transmission Electron Microscope (TEM) images of the carbon-containing matrix. The TEM images of FIG. 4 indicate the formation of stacks of graphitic plates, with sizes less than about 100 nm. FIG. 4 shows a specific example of a graphitic plate having a thickness of about 50 nm. The direction of the high thermal conductivity are along the long axis as shown by the arrows of FIG. 4.

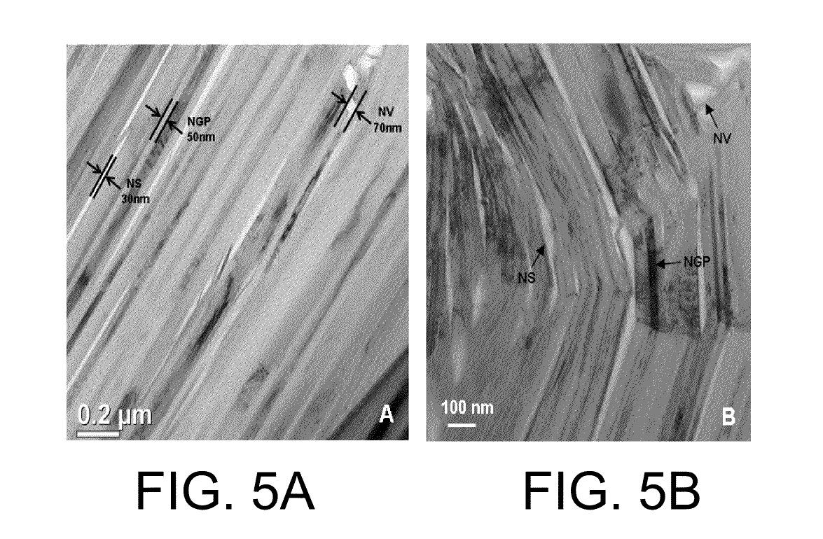

FIGS. 5A and 5B show additional TEM images of the nanographitic plates (labeled as “NGP”) of the carbon-containing matrix. The plates are oriented generally in the direction of the extrusion (FIG. 5A) and the direction of the press process (FIG. 5B). The ordered stacks of the nanographitic plates may promote efficient heat transfer in the direction of the long axis of the plates. FIGS. 5A and 5B also show nanovoids (labeled “NV”) and nanoslits (labeled “NS”), which are artifacts of the manufacturing process using carbon based particles. FIGS. 5A and 5B indicate nanovoids having a thickness of about 70 nm and nanoslits having a thickness of about 30 nm.

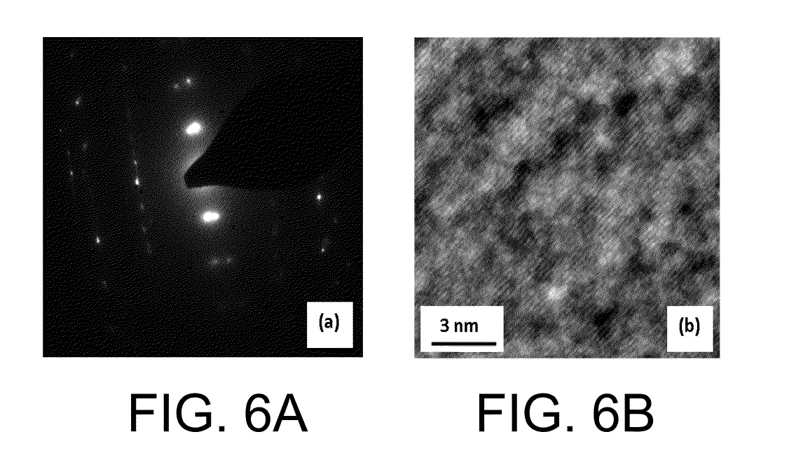

FIGS. 6A and 6B show TEM diffraction patterns and images of the carbon-containing matrix. The TEM diffraction pattern of FIG. 6A and the TEM image of FIG. 6B indicate the crystallinity and graphitic nature of the carbon-containing matrix formed during an extrusion process. In particular, FIG. 6A shows the diffraction pattern produced as the electrons interact with the crystalline lattice of the graphite material. Additionally, FIG. 6B, shows the lattice structure of the graphitic plates.

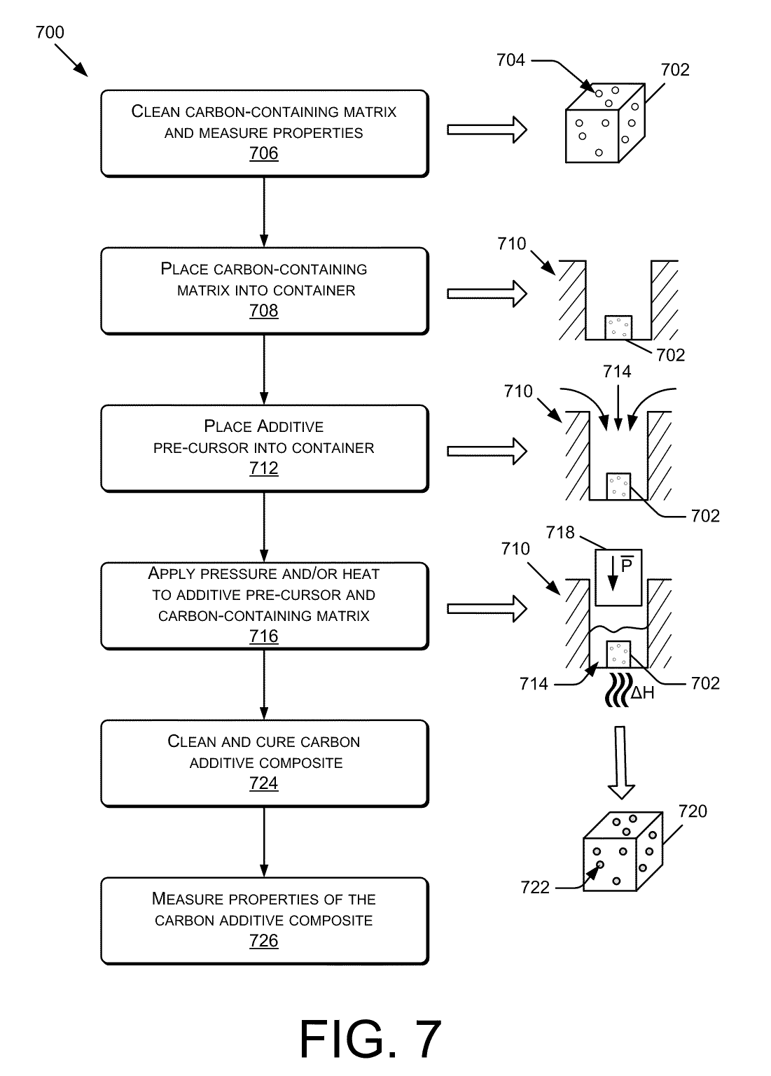

FIG. 7 shows a flow diagram of a method 700 of filling a carbon-containing matrix 702 having a number of pores 704 with an additive that is not a metal. The carbon-containing matrix 702 may be formed as a block, plate, sheet, or a cloth. In addition, the carbon-containing matrix 702 may be amorphous. At 706, the carbon-containing matrix 702 is cleaned and the physical and thermal properties of the carbon-containing matrix 702 are measured. For example, the carbon-containing matrix 702 may be cleaned with an N₂ gun. In some cases, the carbon containing matrix 702 may be a carbon-containing matrix produced via the method 300 of FIG. 3.

At 708, the carbon-containing matrix 702 is placed in a container 710, such as a mold of a reactor press, and at 712, an additive pre-cursor 714 is placed in the container 710. The additive pre-cursor 714 may be a solid, liquid, or gas. The additive pre-cursor 714 may also be a non-metal. For example, the additive pre-cursor 714 may include silicones (e.g. silicone grease, silicone oil), epoxies, polyurethanes, nylons, and SiH₄ gas.

At 716, energy in the form of pressure and/or heat is applied to the additive pre-cursor 714 and the carbon-containing matrix 702. For example, a die 718 may be applied to the additive pre-cursor 714 and the carbon-containing matrix 702. The pressures applied to the additive pre-cursor 714 and the carbon-containing matrix 702 may range from 0 psi to 22000 psi. In some exemplary embodiments when the additive pre-cursor 714 is a liquid or solid polymer, the pressures applied to the additive pre-cursor 714 and the carbon-containing matrix 702 are above 500 psi. In other exemplary embodiments when the additive pre-cursor 714 is a gas, the pressures applied to the additive pre-cursor 714 and the carbon-containing matrix may be below 500 psi, such as a partial vacuum.

In addition, the time that the pressure is applied by the die 718 may range from 5 minutes to 60 minutes. Temperatures applied to the additive pre-cursor 714 and the carbon-containing matrix 702 may range from 800° C. to 1000° C. In some cases, the reactivity of the additive pre-cursor 714 may affect the pressure and/or temperature applied to the additive pre-cursor 714 and the carbon-containing matrix 702 in the container 710. For example, lower pressure and/or temperature may be applied when the additive pre-cursor 714 is a small chain polymer or a gas, while higher pressure and/or temperature may be applied when the additive pre-cursor 714 is a long chain polymer or a solid.

While the pressure and/or temperature are applied to the carbon-containing matrix 702 and the additive pre-cursor 714, the additive pre-cursor 714 may fill at least a portion of the pores 704 of the carbon-containing matrix 702. In addition, a chemical reaction may take place and one or more additive end products, such as the additive 722, may be formed within the pores 704 of the carbon-containing matrix 702 to produce a carbon additive composite 720. The additive 722 is not a metal. At least a portion of the pores 704 of the carbon-containing matrix 702 are filled with the additive 722. In addition, the volume of the pores 704 including the additive 722 may be at least partially filled with the additive 722. In some cases, the viscosity of the additive pre-cursor 714 may affect the amount of the additive 722 disposed within the pores 704. For example, additive pre-cursors 714 having higher viscosities, such as SiH₄ gas or silicone oil, may provide a thin coating of the additive 722 on the pores 704, thereby limiting the amount of the additive 722 disposed in the pores 704. Other additive pre-cursors 714 having higher viscosities, such as epoxies, nylons, and silicone grease, may fill a greater volume of the pores 704. Further, the pressure and/or temperature applied to the carbon-containing matrix 702 and the additive pre-cursor 714, as well as the amount of time that the pressure and/or temperature are applied may affect the amount of the additive 722 disposed within the pores 704.

When the additive pre-cursor 714 includes Si, SiC may be formed when the Si of the additive pre-cursor 714 reacts with the C of the carbon-containing matrix 702. In a particular example, silicone oil reacts with carbon according to the following reaction:

(—SiC₂H₆O—)n→SiO+2C+2H₂→SiC+CO

as described in “Thermal Decomposition of Commercial Silicone Oil to Produce High Yield High Surface Area SiC Nanorods,” by V. G. Pol, S. V. Pol, A. Gedanken, S. H. Lim, Z. Zhong, and J. Lin, J. Phys. Chem. B 2006, 110, 11237-11240, which is incorporated by reference herein. In this way, SiC may be formed within the pores 704 of the carbon-containing matrix 702. SiC has a good affinity with the carbon of the carbon-containing matrix 702. So, a good interface may form between the SiC and the carbon-containing matrix 702 that results in improved flexibility and strength of the carbon additive composite 720. In particular, the bend strength of the carbon additive composite 720 may increase between the range of 20% to 275% when compared with the bend strength of the carbon-containing matrix 702. Additionally, phonon coupling and heat transfer through the pores 704 may also be increased due to the interface between the SiC and the carbon-containing matrix 702. Thus, the thermal conductivity of the carbon additive composite 720 may increase. For example, the thermal conductivity of the carbon additive composite 720 may increase between the range of 5% and 30% when compared with the thermal conductivity of the carbon-containing matrix 702.

At 724, the carbon additive composite 720 is cleaned and cured. For example, excess additive pre-cursor 714 may be wiped off with alcohol wipers and the carbon additive composite 720 may be air dried. Then, the carbon additive composite 720 may be cured at temperatures in a range of 100° C. to 185° C. for a duration between a range of 1 hour to 6 hours. At 726, properties of the carbon additive composite 720 are measured. For example, the bending strength may be measured by a 3-point bend method. In addition, the thermal conductivity may be measured by a laser flash analysis (LFA) method, such as ASTM E1461.

Although the method 700 describes filling the pores 704 of the carbon-containing matrix 702 with an additive 722 that is not a metal, other materials may also be disposed within the pores 704 of the carbon-containing matrix 702 via a chemical reaction, such as via a high pressure impregnation reaction (HPIR). For example, metals (Li, B, Si, Zn, Ag, Cu, Al, Ni, Pd, Sn Ga etc.), alloys (Cu—Zn, Al—Zn, Li—Pd Al—Mg, Mg—Al—Zn etc.), compounds (ITO, SnO₂, NaCl, MgO, SiC, MN, Si₃N₄, GaN, ZnO, ZnS etc.), and semiconductor super-lattice or quantum dots (InGaN, AlGaN, InNAs, GaAsP etc.) may be formed in the pores 704 of the carbon-containing matrix 702.

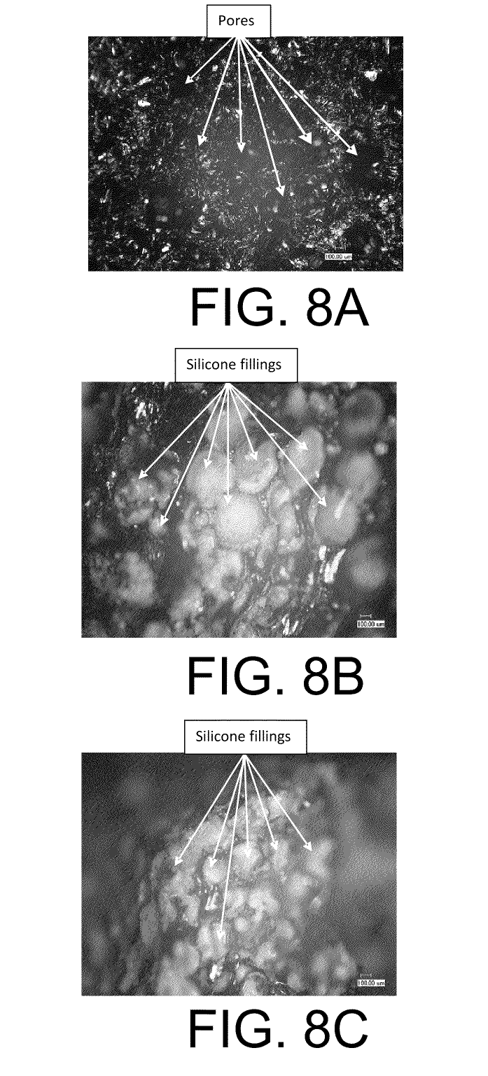

FIGS. 8A-8C show microscopy photographs of a carbon-containing matrix before and after disposing silicone grease within the pores of the carbon-containing matrix. In particular, FIG. 8A shows unfilled pores of the carbon-containing matrix. Some of the unfilled pores are indicated by white arrows. FIG. 8B shows pores of the carbon-containing matrix filled with silicone grease. Some of the filled pores are indicated by white arrows. Additionally, FIG. 8C shows pores of the carbon-containing matrix filled with silicone grease after curing. Some of the filled pores are indicated by white arrows.

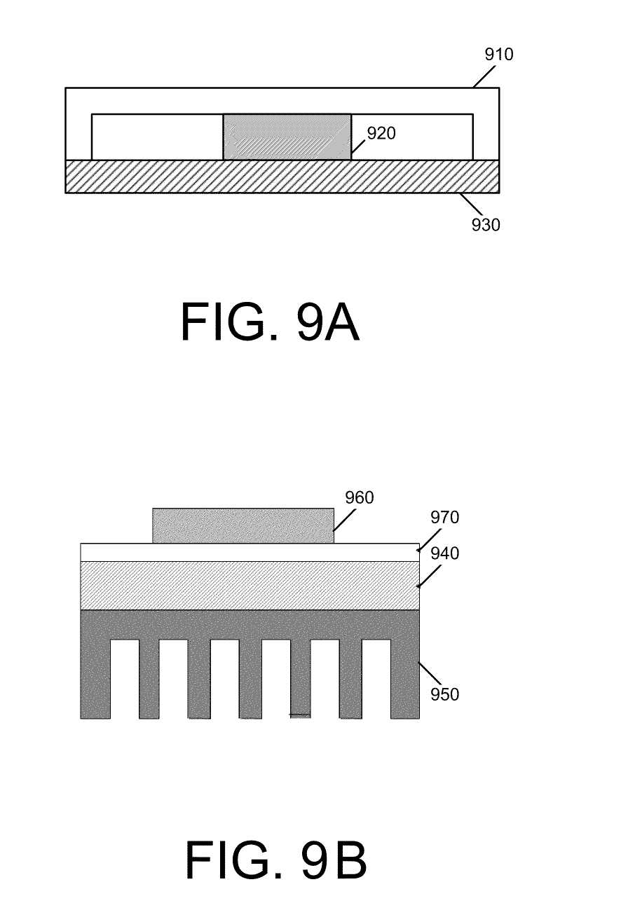

FIGS. 9A and 9B illustrate heat transfer devices that may utilize a carbon-containing matrix filled with an additive that is not a metal. In one example, a carbon additive composite may be utilized as a heat spreader, such as the heat spreader 910 shown in FIG. 9A. In particular, the carbon additive composite may be machined into the heat spreader 910 that dissipates heat from a computer chip 920 coupled to a substrate 930. Additionally, the carbon additive composite may be used as a heat spreader coupled to a light emitting diode (LED). In another example shown in FIG. 9B, a carbon additive composite 940 may be coupled to a heat sink 950 that is coupled to a computer chip 960, such as an insulated-gate bipolar transistor (IGBT), via an insulating layer 970.

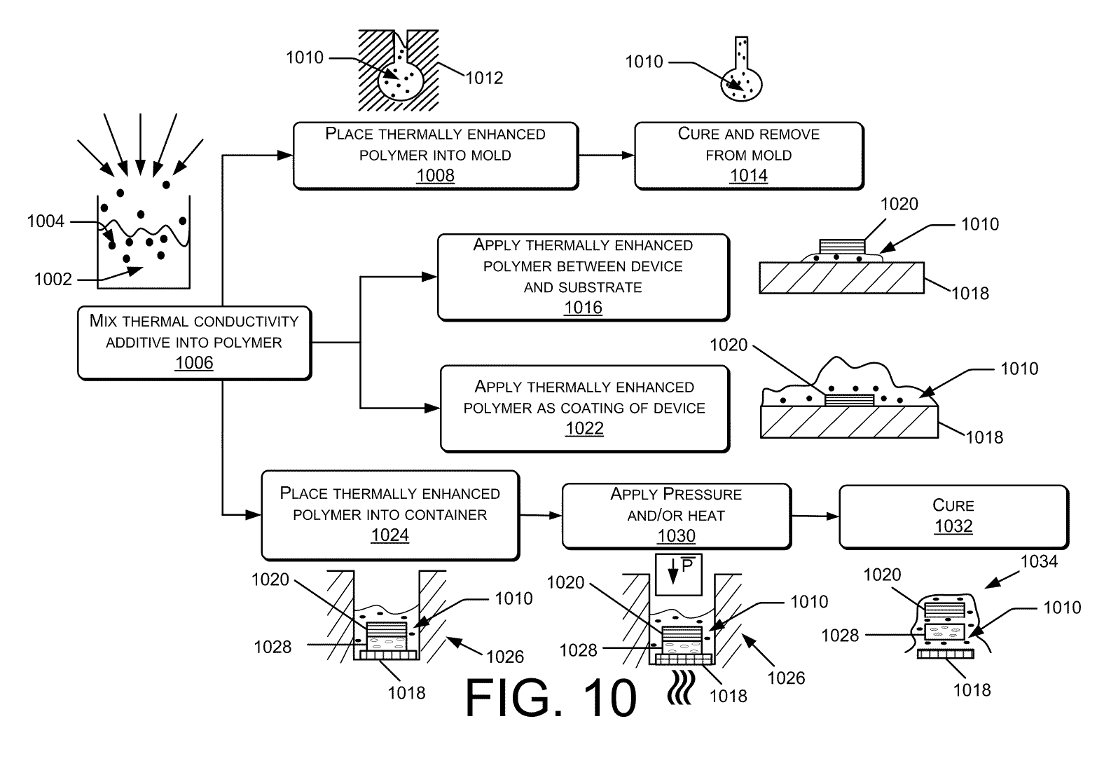

FIG. 10 shows applications of a polymer 1002 including thermal conductivity additives 1004. In particular, at 1006, the thermal conductivity additives 1004 are mixed with the polymer 1002. The amount of the thermal conductivity additives 1004 should not exceed the limit that ensures the polymer 1002 can still keep enough adhesive strength and dialectical strength to fulfill the piratical application requirement. The polymer 1002 may be a silicone based polymer. In addition, the polymer 1002 may have a shore durometer between about 5 on the A type scale and about 100 on the A type scale.

The thermal conductivity additives 1004 may be organic materials or inorganic materials. Examples of organic thermal conductivity additives 1004 include graphite particulates, carbon nanotubes, graphene sheets, C₆₀ (Buckminster Fullerene), or combinations thereof. Further, examples of inorganic thermal conductivity additives 1004 include nanoparticulate metal, carbon-coated nanoparticulate metal, Si-coated nanoparticulate metal, particulate metal oxide, particulate metal nitride, particulate metal carbide, or combinations thereof. The thermal conductivity additives 1004 may also include dust or flakes from a carbon-metal composite material, such as a C—Al composite material or a C—Al—Si composite material. In some cases, the C—Al composite material and the C—Al—Si composite material may be formed by injecting a porous carbon-containing matrix with Al or an Al alloy including Si.

The thermal conductivity additives 1004 increase the thermal conductivity of the polymer 1002. In some cases, the thermal conductivity additives 1004 also improve the mechanical strength of the polymer 1002. The types and amounts of thermal conductivity additives 1004 mixed with the polymer 1002 may depend on a desired thermal conductivity of the polymer 1004 after the thermal conductivity additives 1004 have been added. The polymer 1002 including the thermal conductivity additives 1004 may be referred to herein as a “thermally enhanced polymer” 1010.

The thermally enhanced polymer 1010 may be used in a variety of applications. For example, at 1008, the thermally enhanced polymer 1010 may be placed in a mold 1012. The thermally enhanced polymer 1010 may be molded into a particular shape via injection molding, cast molding, pressure molding, pressure-injection molding, or a combination thereof. In some cases, the thermally enhanced polymer 1010 may be molded into a lid for a computer chip.

At 1014, the thermally enhanced polymer 1010 may be removed from the mold and cured under appropriate conditions depending on the composition of the thermally enhanced polymer 1010. For example, heat may be applied to the thermally enhanced polymer 1010 for a specified functional amount of time. Additionally, the thermally enhanced polymer 1010 may be cured via exposure to ultraviolet radiation.

At 1016, the thermally enhanced polymer 1010 is used as an adhesive and applied to a substrate 1018. In this way, a device 1020, such as a computer chip, is placed on the thermally enhanced polymer 1010 and bonded with the substrate 1018. The thermally enhanced polymer 1010 may then act as a thermal management material to aid in the transfer of heat away from the device 1020 to the substrate 1018.

Further, at 1022, the thermally enhanced polymer 1010 is applied as a coating to the device 1020 and the substrate 1018. When applied as a coating, the thermally enhanced polymer 1010 may spread heat away from the device 1020.

At 1024, the thermally enhanced polymer 1010 is placed into a container 1026. Additionally, the substrate 1018 and the device 1020 may be placed into the container 1026. A carbon-containing matrix 1028 may also be placed into the container 1026. In some cases, the carbon-containing matrix 1028 may include unfilled pores, while in other cases the carbon-containing matrix 1028 may include filled or partially filled pores. The carbon-containing matrix 1028 may be positioned between the substrate 1018 and the device 1020

At 1030, pressure and/or heat are applied to the thermally enhanced polymer 1010, the substrate 1018, the device 1020, and the carbon-containing matrix 1028. The amount of pressure applied may be in a range of 500 psi to 11,000 psi. In addition, the temperature applied may be in a range of 800° C. to 1000° C. As pressure and/or temperature are applied to the thermally enhanced polymer 1010, the substrate 1018, the device 1020, and the carbon-containing matrix 1028, the thermally enhanced polymer 1010 may become disposed between the carbon-containing matrix 1028 and the substrate 1018 and between the carbon-containing matrix 1028 and the device 1020. Thus, the thermally enhanced polymer 1010 may be an adhesive to bind the substrate 1018, the device 1020, and the carbon-containing matrix 1028. The thermally enhanced polymer 1010 may also provide a coating to the substrate 1010, the device 1020, and the carbon-containing matrix 1028 to facilitate heat transfer away from the device 1020.

Additionally, the thermally enhanced polymer 1010 may be disposed within pores of the carbon-containing matrix 1028. In some cases, the thermally enhanced polymer 1010 may be a pre-cursor that reacts with the carbon of the carbon-containing matrix 1028 to form one or more end products within the pores of the carbon-containing matrix 1028. For example, a high pressure impregnation reaction may take place when pressure and/or temperature are applied to the substrate 1018, the device 1020, the carbon-containing matrix 1028, and the thermally enhanced polymer 1010. When the thermally enhanced polymer 1010 includes Si, the end products may include SiC.

By utilizing the thermally enhanced polymer 1010 as an adhesive between the carbon-containing matrix 1028 and the substrate 1018 and the carbon-containing matrix 1028 and the device 1020, the heat transfer away from the device 1020 may be improved. By filling pores of the carbon-containing matrix 1028 with the thermally enhanced polymer 1010, the strength and flexibility, as well as the thermal conductivity, of the carbon-containing matrix 1028 may also be increased.

At 1032, the thermally enhanced polymer 1010, the substrate 1018, the device 1020, and the carbon-containing matrix 1028 are cured at a temperature between about 100° C. and 200° C. to produce a thermal management system 1034.

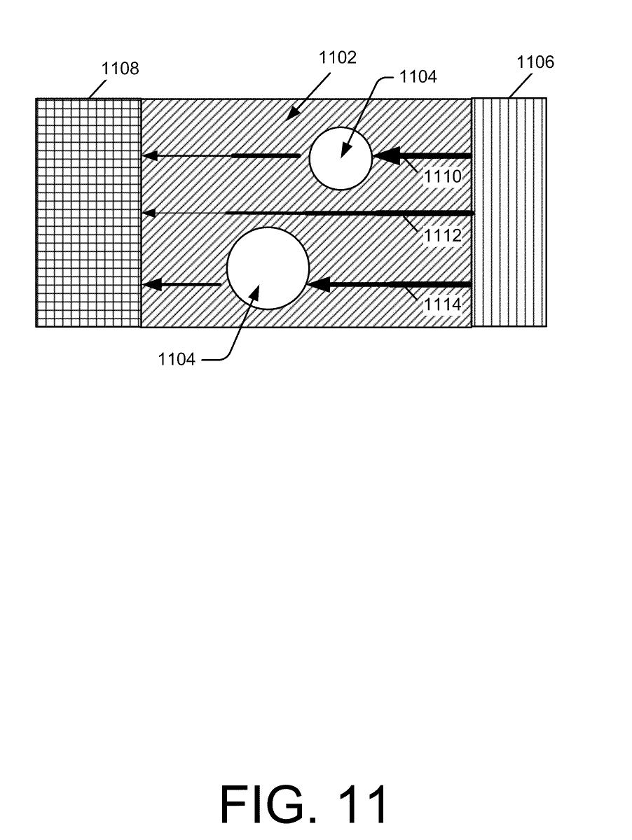

FIG. 11 illustrates heat transfer through a polymer 1102 including thermal conductivity additives 1104. In particular, the polymer 1102 is disposed between a heat-producing device 1106 and a substrate 1108. The heat producing device 1106 may be an electronic device, such as a computer chip.

The arrows 1110-1114 of FIG. 11 show the flow of heat from the heat-producing device 1106 to the substrate 1108. The thickness of the arrows 1110-1114 represents greater amounts of heat transfer. As can be seen from FIG. 11, heat flow through the polymer 1102 is greater when the thermal conductivity additives 1104 are in the path of the heat. In particular, the thermal conductivity additives 1104 improve the heat transfer from the heat-producing device 1106 to the substrate 1108 because the thermal conductivity additives 1104 have a higher thermal conductivity than the polymer 1102.

In the illustrative example of FIG. 11, the thickness of the arrows 1110-1114 decreases as the arrows progress through the polymer 1102 from the device 1106 to the substrate 1108 indicating less heat transfer from the device 1106 to the substrate 1108. The arrows 1110 and 1114 show heat that comes in contact with the thermal conductivity additives 1104, while the arrow 1112 indicates heat that travels only through the polymer 1102. Thus, the arrows 1110 and 1114 indicate greater heat transfer from the device 1106 to the substrate 1108 than the arrow 1112.

In some cases, the nature of the interface between the thermal conductivity additives 1104 and the polymer may affect heat transfer from the device 1106 to the substrate 1108. For example, when the polymer 1104 is a silicone polymer and the thermal conductivity additives 1104 include carbon, a SiC interface may form between the polymer 1102 and the thermal conductivity additives 1104. The SiC interface has high thermal conductivity that allows greater amounts of heat transfer through the thermal conductivity additives 1104. In another example, the polymer 1102 may be a silicone polymer and the thermal conductivity additives 1104 may be metallic. Metal thermal conductivity additives 1104 often have a lower affinity with a silicone polymer, in relation to carbon-based thermal conductivity additives 1104. Thus, the interface between metallic thermal conductivity additives 1104 and a silicon polymer 1102 may disrupt heat transfer between the polymer 1102 and the thermal conductivity additives 1104 and decrease heat transfer through the thermal conductivity additives 1104. In some instances, applying a carbon-based coating to metallic thermal conductivity additives 1104 may improve the interface between the polymer 1102 and the metallic thermal conductivity additives 1104.

Several examples of disposing an additive that is not a metal in pores of a carbon-containing matrix according to the method 700 are given below.

### EXAMPLES

### Example 1

A POCO high temperature carbon (HTC) carbon-containing matrix formed as a thin plate was placed in a high pressure mold with Dow Corning 3-6751 silicone grease. The POCO HTC carbon-containing matrix had a density of about 0.9 g/cm³, a total porosity of about 61%, open pore porosity of about 57.9%, a thermal conductivity in the z-direction of about 245 W/mK, and thermal conductivity in the x/y direction of about 70 W/mK. The Dow Corning 3-6751 silicone grease had a density of about 2.3 g/cm³, a viscosity of about 10000 cp, and a thermal conductivity of about 1.1 W/mK. Samples of a POCO HTC carbon containing matrix were cleaned with an N₂ gun and the initial weight was measured. The POCO HTC carbon-containing matrix and the Dow Corning 3-6751 silicone grease were placed in a high pressure mold and pressure of about 22000 psi was applied for various times to different samples for a duration of a range of 5 minutes to 60 minutes. After the pressure was released, the samples were wiped with alcohol wipers and air dried. The sample weight was measured and then the samples were cured at about 100° C. for about one hour. The sample weight after curing was measured. Process conditions and measurements of properties of the carbon-containing matrix and the carbon additive are shown in Table 1.

TABLE 1

| | | | | | | Grease | Grease | |
|---|---|---|---|---|---|---|---|---|
| | | | | | | weight | volume | Open |
| | | | Carbon | After | After | ratio | ratio | pore |
| | | | Block | Impregnation | Curing | after | after | filling |
| Sample | Pressure | Time | weight | weight | weight | curing | curing | ratio |
| No. | (psi) | (min) | (g) | (g) | (g) | (Wt. %) | (vol. %) | (%) |
| 01 | 22000 | 60 | 1.4972 | 2.4878 | 2.8457 | 47.4 | 35.2 | 60.9 |
| 05 | 22000 | 30 | 1.4379 | 2.8425 | 2.8384 | 49.3 | 38.1 | 65.8 |
| 03 | 22000 | 15 | 1.4029 | 2.6615 | 2.6507 | 47.1 | 34.8 | 60.1 |
| 04 | 22000 | 5 | 1.4548 | 2.9410 | 2.9402 | 50.5 | 40.0 | 69.0 |

### Example 2

A POCO HTC carbon-containing matrix formed as a thin plate was placed in a high pressure mold with Dow Corning 3-6751 silicone grease. The POCO HTC carbon-containing matrix had a density of about 0.9 g/cm³, a total porosity of about 61%, open pore porosity of about 57.9%, a thermal conductivity in the z-direction of about 245 W/mK, and thermal conductivity in the x/y direction of about 70 W/mK. The Dow Corning 3-6751 silicone grease had a density of about 2.3 g/cm³, a viscosity of about 10000 cp, and a thermal conductivity of about 1.1 W/mK. Samples of a POCO HTC carbon-containing matrix were cleaned with an N₂ gun and the initial weight was measured. The POCO HTC carbon-containing matrix and the Dow Corning 3-6751 silicone grease were placed in a high pressure mold and varying pressure between a range of 0 psi to 22000 psi was applied for about 15 minutes to different samples. After the pressure was released, the samples were wiped with alcohol wipers and air dried. The sample weight was measured and then the samples were cured at about 100° C. for about one hour. The sample weight after curing was then measured. Process conditions and measurements of properties of the carbon-containing matrix and the carbon additive composite are shown in Table 2.

TABLE 2

| | | | | | | Grease | Grease | |
|---|---|---|---|---|---|---|---|---|
| | | | | | | weight | volume | Open |
| | | | Carbon | After | After | ratio | ratio | pore |
| | | | Block | Impregnation | Curing | after | after | filling |
| Sample | Pressure | Time | weight | weight | weight | curing | curing | ratio |
| No. | (psi) | (min) | (g) | (g) | (g) | (Wt. %) | (vol. %) | (%) |
| 03 | 22000 | 15 | 1.4029 | 2.6615 | 2.6507 | 47.1 | 34.8 | 60.1 |
| 06 | 16500 | 15 | 1.4003 | 2.8065 | 2.7998 | 50.0 | 39.1 | 67.5 |
| 07 | 22000 | 15 | 1.3814 | 2.8259 | 2.8222 | 51.1 | 40.8 | 70.5 |
| 08 | 11000 | 15 | 1.3284 | 2.8342 | 2.8228 | 52.9 | 44.0 | 76.0 |
| 09 | 5500 | 15 | 1.5210 | 3.1197 | 3.1074 | 51.1 | 40.8 | 70.5 |
| 16 | 1320 | 15 | 1.3210 | 2.7463 | 2.7350 | 51.7 | 41.9 | 72.3 |
| 12 | 550 | 15 | 1.4105 | 2.9104 | 2.9037 | 51.4 | 41.4 | 71.5 |
| 15 | 220 | 15 | 1.3879 | 1.9934 | 1.9895 | 30.2 | 17.0 | 29.3 |
| 13 | 2.2 | 15 | 1.3474 | 1.8033 | 1.7990 | 25.1 | 13.1 | 22.7 |
| 11 | 0 | 15 | 1.4037 | 1.5371 | 1.5333 | 8.4 | 3.61 | 6.2 |

### Example 3

A POCO HTC carbon-containing matrix formed as a thin plate was placed in a high pressure mold with Dow Corning 3-6751 silicone grease. The POCO HTC carbon-containing matrix had a density of about 0.9 g/cm³, a total porosity of about 61%, open pore porosity of about 57.9%, a thermal conductivity in the z-direction of about 245 W/mK, and thermal conductivity in the x/y direction of about 70 W/mK. The Dow Corning 3-6751 silicone grease had a density of about 2.3 g/cm³, a viscosity of about 10000 cp, and a thermal conductivity of about 1.1 W/mK. Samples of a POCO HTC carbon-containing matrix were cleaned with an N₂ gun and the initial weight was measured. The POCO HTC carbon-containing matrix and the Dow Corning 3-6751 silicone grease were placed in a high pressure mold and pressure of about 550 psi was applied for about 15 minutes. After the pressure was released, the samples were wiped with alcohol wipers and air dried. The sample weight was measured and then the samples were cured at about 100° C. for about one hour. The sample weight after curing was then measured. Measurements of properties of the carbon-containing matrix and the carbon additive composite are shown in Table 3.

TABLE 3

| | | | | Grease | | | | |
|---|---|---|---|---|---|---|---|---|
| | | | | Weight | | Grease | Grease | |
| | | | | Loss | Mass | weight | volume | Open |
| | Carbon | After | After | Ratio | Density | ratio | ratio | pore |
| | Block | Impregnation | Curing | After | after | after | after | filling |
| Sample | weight | weight | weight | Curing | curing | curing | curing | ratio |
| No. | (g) | (g) | (g) | (%) | (g/cm³) | (Wt. %) | (vol. %) | (%) |
| 31 | 4.9700 | 10.9374 | 10.8385 | 0.9 | 1.81 | 54.1 | 46.2 | 79.8 |
| 33 | 5.1144 | 11.2992 | 11.2259 | 0.6 | 1.88 | 54.4 | 46.8 | 80.7 |

### Example 4

A POCO HTC carbon-containing matrix formed as a thin plate was placed in a high pressure mold with Dow Corning 3-6751 silicone grease. The POCO HTC carbon-containing matrix had a density of about 0.9 g/cm³, a total porosity of about 61%, open pore porosity of about 57.9%, a thermal conductivity in the z-direction of about 245 W/mK, and thermal conductivity in the x/y direction of about 70 W/mK. The Dow Corning 3-6751 silicone grease had a density of about 2.3 g/cm³, a viscosity of about 10000 cp, and a thermal conductivity of about 1.1 W/mK. Samples of a POCO HTC carbon-containing matrix were cleaned with an N₂ gun and the initial weight was measured. The POCO HTC carbon-containing matrix and the Dow Corning 3-6751 silicone grease were placed in a high pressure mold and pressure of about 550 psi was applied for about 15 minutes. After the pressure is released, the samples were wiped with alcohol wipers and air dried. The sample weight was measured and then the samples were cured at about 100° C. for about one hour. The sample weight was measured and the bending strength was tested by a 3-point bend method. The bending strength of bare carbon blocks that were not impregnated with the Dow Corning 3-6751 silicone grease is also measured by the 3-point bend method. Thermal conductivity of samples was tested by the ASTM E1461 Flash Method. Measurements of properties of the carbon-containing matrix and the carbon additive composite are shown in Tables 4 and 5.

TABLE 4

| | | | | Grease | Grease | | | |
|---|---|---|---|---|---|---|---|---|
| | | | After | weight | volume | Open | | |
| | | Carbon | Impregnation | ratio | ratio | pore | | Bending |
| | Bare | Block | & Curing | after | after | filling | Bending | Strength |
| Sample | Carbon | weight | weight | curing | curing | ratio | Strength | Reinforcement |
| No. | Block | (g) | (g) | (Wt. %) | (vol. %) | (%) | (MPa) | (%) |
| 20 X | Yes | | | | | | 2.70 | |
| 19 X | No | 1.3246 | 2.9135 | 54.5 | 46.9 | 81.1 | 3.39 | 25.6 |
| 24 Y | Yes | | | | | | 2.86 | |
| 23 Y | No | 1.3701 | 3.1127 | 56.0 | 49.8 | 86.0 | 3.59 | 25.5 |
| 28 Z | Yes | | | | | | 3.06 | |
| 27 Z | No | 1.3299 | 2.8421 | 53.2 | 44.5 | 76.8 | 3.59 | 17.3 |

TABLE 5

| | | Bulk | | | |
|---|---|---|---|---|---|
| | Thickness | Density | Specific | Thermal | Thermal |
| Sample | @ 25° C. | @ 25° C. | Heat | Diffusivity | Conductivity |
| No. | (mm) | (g/cm³) | (J/g-K) | (mm²/s) | (W/m-K) |
| 31 X | 2.85 | 1..93 | 0.777 | 43.0 | 64.515 |
| 32 Y | 2.76 | 1.95 | 0.864 | 43.6 | 73.45 |
| 33 Z | 2.94 | 1.95 | 0.824 | 173 | 277.565 |

### Example 5

A POCO HTC carbon containing-matrix formed as a thin plate was placed in a high pressure mold with Master Bond EP 112 epoxy. The POCO HTC carbon-containing matrix had a density of about 0.9 g/cm³, a total porosity of about 61%, open pore porosity of about 57.9%, a thermal conductivity in the z-direction of about 245 W/mK, and thermal conductivity in the x/y direction of about 70 W/mK. The Master Bond EP112 epoxy had a density of about 1.0 g/cm³ and a viscosity of about 300-400 cp. Samples of a POCO HTC carbon-containing matrix were cleaned with an N₂ gun and the initial weight was measured. The POCO HTC carbon-containing matrix and the Master Bond EP112 epoxy were placed in a high pressure mold and pressure of about 550 psi was applied for about 15 minutes. After the pressure was released, the samples were wiped with alcohol wipers and air dried. The sample weight was measured and then the samples were cured at about 185° C. for about six hours. The sample weight was measured, the bending strength was tested by a 3-point bend method, and the thermal conductivity was measured by the ASTM E1461 Flash Method. Measurements of properties of the carbon-containing matrix and the carbon additive composite are shown in Tables 6, 7, and 8.

TABLE 6

| | | | | | | Epoxy | Epoxy | |
|---|---|---|---|---|---|---|---|---|
| | | | | Epoxy | | weight | volume | |
| | | | | Weight | Mass | ratio | ratio | Open |
| | Carbon | After | After | Loss Ratio | Density | after | after | pore |
| | Block | Impregnation | Curing | After | after | curing | curing | filling |
| Sample | weight | weight | weight | Curing | curing | (Wt. | (vol. | ratio |
| No. | (g) | (g) | (g) | (%) | (g/cm³) | %) | %) | (%) |
| 44 X | 6.4448 | 9.9895 | 9.1476 | 8.5 | 1.28 | 29.5 | 37.7 | 65.2 |
| 45 Y | 6.5525 | 9.8280 | 8.9571 | 8.9 | 1.23 | 26.8 | 33.0 | 57.0 |
| 46 Z | 6.6930 | 10.1307 | 9.1105 | 10.0 | 1.23 | 26.5 | 32.5 | 56.1 |

TABLE 7

| | Bare | | Bending Strength |
|---|---|---|---|
| Sample | Carbon | Bending | Reinforcement |
| No. | Block | Strength (MPa) | (%) |
| 20 X | Yes | 2.70 | |
| 38 X | No | 9.82 | 264 |
| 24 Y | Yes | 2.86 | |
| 40 Y | No | 9.91 | 247 |
| 28 Z | Yes | 3.06 | |
| 42 Z | No | 9.60 | 213 |

TABLE 8

| | | Bulk | | | |
|---|---|---|---|---|---|
| | Thickness | Density | Specific | Thermal | Thermal |
| Sample | @ 25° C. | @ 25° C. | Heat | Diffusivity | Conductivity |
| No. | (mm) | (g/cm³) | (J/g-K) | (mm²/s) | (W/m-K) |
| 44 X | 3.06 | 1.17 | 0.894 | 75.8 | 78.914 |
| 45 Y | 2.92 | 1.18 | 0.821 | 96.8 | 93.409 |
| 46 Z | 2.99 | 1.17 | 0.803 | 303 | 285.085 |

### Example 6

A POCO HTC carbon-containing matrix formed as a thin plate was placed in a high pressure mold with Silicone Sealer. The POCO HTC carbon-containing matrix had a density of about 0.9 g/cm³, a total porosity of about 61%, open pore porosity of about 57.9%, a thermal conductivity in the z-direction of about 245 W/mK, and thermal conductivity in the x/y direction of about 70 W/mK. The Silicone Sealer had a density of about 1.0 g/cm³. Samples of a POCO HTC carbon-containing matrix were cleaned with an N₂ gun and the initial weight was measured. The POCO HTC carbon-containing matrix and the Silicone Sealer were placed in a high pressure mold and pressure of about 550 psi was applied for about 15 minutes. For one sample, the pressure was about 2750 psi. After the pressure was released, the samples were wiped with alcohol wipers and air dried. The sample weight was measured and then the samples were cured at about 100° C. for about six hours. The sample weight was measured and the bending strength was tested by a 3-point bend method. Measurements of properties of the carbon-containing matrix and the carbon additive composite are shown in Tables 9 and 10.

TABLE 9

| | | | Mass | | | |
|---|---|---|---|---|---|---|
| | Carbon | After | Density | Silicone Sealer | | |
| | Block | Impregnation | after | weight | Silicone Sealer | Open pore |
| Sample | weight | weight | curing | ratio | volume ratio | filling ratio |
| No. | (g) | (g) | (g/cm³) | (Wt. %) | (vol. %) | (%) |
| 47 Z | 0.6477 | 1.0126 | 1.41 | 36.0 | 50.7 | 87.6 |
| 48 Z | 0.9081 | 1.3998 | 1.39 | 35.1 | 48.7 | 84.1 |
| 49 Z | 0.6969 | 10.1307 | 1.33 | 32.1 | 42.5 | 73.4 |
| (2750 psi) | | | | | | |
| 50 Z | 1.5758 | 2.5653 | 1.47 | 38.4 | 56.4 | 85.4 |

TABLE 10

| | Bare | | Bending Strength |
|---|---|---|---|
| Sample | Carbon | Bending | Reinforcement |
| No. | Block | Strength (MPa) | (%) |
| 28 Z | Yes | 3.06 | |
| 50 Z | No | 4.92 | 60.8 |

### Example 7

A POCO HTC carbon-containing matrix formed as a thin plate was placed in a high pressure mold with Nylon 11. The POCO HTC carbon-containing matrix had a density of about 0.9 g/cm³, a total porosity of about 61%, open pore porosity of about 57.9%, a thermal conductivity in the z-direction of about 245 W/mK, and thermal conductivity in the x/y direction of about 70 W/mK. The Nylon 11 had a density of about 1.0 g/cm³. Samples of a POCO HTC carbon-containing matrix were cleaned with an N₂ gun and the initial weight was measured. The POCO HTC carbon-containing matrix and the Nylon 11 were placed in a high pressure mold and pressure of about 550 psi was applied for about 15 minutes at a temperature of about 260° C. After the pressure was released, the samples were wiped with alcohol wipers and air dried. The sample weight was measured and the bending strength was tested by a 3-point bend method. Measurements of properties of the carbon-containing matrix and the carbon additive composite are shown in Tables 11 and 12.

TABLE 11

| | Carbon | After | | | | |
|---|---|---|---|---|---|---|
| | Block | Impregnation | Mass | | Nylon volume | Open pore |
| Sample | weight | weight | Density | Nylon weight | ratio | filling ratio |
| No. | (g) | (g) | (g/cm³) | ratio (Wt. %) | (vol. %) | (%) |
| 53 Z | 8.6949 | 12.9385 | 1.31 | 32.8 | 43.9 | 75.9 |

TABLE 12

| | Bare | | Bending Strength |
|---|---|---|---|
| Sample | Carbon | Bending | Reinforcement |
| No. | Block | Strength (MPa) | (%) |
| 28 Z | Yes | 3.06 | |
| 53 Z | No | 9.84 | 221.6 |

1. A composition of matter comprising:
a carbon-containing matrix comprising a plurality of pores; and
an additive that is not a metal pressure disposed within at least a portion of the plurality of pores.

2. The composition of matter of claim 1, wherein the carbon-containing matrix is constructed from at least one type of carbon material selected from the group comprising graphite crystalline carbon materials, carbon powder, artificial graphite powder, carbon fibers, and combinations thereof.

3. The composition of matter of claim 1, wherein the additive is an Si-containing additive.

4. The composition of matter of claim 1 having a bending strength in the range of 3.50 MPa to 10.00 MPa.

5. The composition of matter of claim 1, wherein the additive is disposed as a coating within at least a portion of the plurality of pores.

6. The composition of matter of claim 1, having an open pore filling ratio in the range of 5% to 90%.

7. The composition of matter of claim 1, wherein the additive is formed by a high pressure impregnation reaction.

8. The composition of matter of claim 1, further comprising one or more thermal conductivity additives.

9. The composition of matter of claim 1, wherein the thermal conductivity additives are selected from a group comprising carbon nanotubes, nanoparticulate metal, carbon-coated nanoparticulate metal, Si-coated nanoparticulate metal, particulate metal nitride, particulate metal carbide, particulate graphite, graphene sheets, C₆₀, carbon-metal composite dust, and combinations thereof.

10. The composition of matter of claim 1 formed into a plate having a thermal conductivity in the x-direction greater than about 65 W/mK, a thermal conductivity in the y-direction greater than about 70 W/mK, and a thermal conductivity in the z-direction greater than about 275 W/mK.

11. The composition of matter of claim 1, having a mass density after curing in the range of 1.20 g/cm³ to 1.90 g/cm³.

12. The composition of matter of claim 1, wherein a volume ratio of the additive after curing is within the range of 3% to 50%.

13. The composition of matter of claim 1, wherein a weight ratio of the additive after curing is within the range of 5% to 60%.

14. A method of making the composition of matter of claim 1 comprising:
providing the carbon-containing matrix and an additive pre-cursor, the additive pre-cursor selected from a group comprising a silicone polymer, silicone oil, silicone grease, a nylon, an epoxy, a polyurethane, SiH₄ gas, and combinations thereof; and
initiating a reaction between the carbon and the additive pre-cursor to form the additive that is not a metal disposed within the at least a portion of the plurality of pores of the carbon-containing matrix.

15. The method of claim 14, wherein the reaction is initiated by pressurizing the carbon-containing matrix and the additive pre-cursor to a pressure greater than about 500 psi for a duration in the range of 15 minutes to 60 minutes.

16. The method of claim 14, wherein the reaction is initiated by heating the carbon-containing matrix and the additive pre-cursor to a temperature in the range of 800° C. to 1000° C.

17. The method of claim 14, wherein the additive pre-cursor has a viscosity in the range of 300-10,000 cp.

18. The method of claim 14, further comprising curing the composition of matter of claim 1 at a temperature in the range of 100° C. to 185° C. for a duration in the range of 1 hour to 6 hours.

19. An article of manufacture made by machining the composition of matter of claim 1 into a heat transfer device.

20. A composition of matter made by a method comprising:
providing a carbon-containing matrix including a plurality of pores and an additive pre-cursor, the carbon-containing matrix comprising one or more materials selected from the group comprising graphite crystalline carbon materials, carbon powder, artificial graphite powder, carbons fibers, and combinations thereof, and the additive pre-cursor selected from a group comprising a silicone polymer, silicone oil, silicone grease, SiH₄ gas, and combinations thereof;
reacting the carbon and the additive pre-cursor to form an additive that is not a metal within at least a portion of the plurality of pores, the additive comprising one or more materials selected from the group comprising C, SiC, Si, and combinations thereof.
